(19) United States
(12) Patent Application Publication
(10) Pub. No.: US 2025/0222970 A1
(43) Pub. Date: Jul. 10, 2025

(54) CORNER PROTECTOR SYSTEM

(71) Applicant: JAVIER LOPEZ, YORBA LINDA, CA (US)

(72) Inventor: JAVIER LOPEZ, YORBA LINDA, CA (US)

(21) Appl. No.: 18/408,283

(22) Filed: Jan. 9, 2024

(51) Int. Cl. B62B 5/00

(52) U.S. Cl. CPC B62B 5/0006

(57) ABSTRACT

The present invention is a corner protector system that can be installed to a concrete pilaster, wall, post, or column. The corner protector system can be applied to a variety of different types of corners such as right angle corners, 60° corners, or 30° corners. The corner protection system has an edge panel. The edge panel is configured to conform to a corner and configured to cover a corner edge. A right panel connects to the edge panel and extends to the right of the edge panel. The left panel connects to the edge panel and extends to the left of the left panel. The edge panel folds between a flat configuration and a right angle folded configuration. The right panel has a right panel overlap that overlaps the edge panel. The left panel has a left panel overlap that overlaps the edge panel.

### SUMMARY OF THE INVENTION

The present invention is a corner protector system that can be installed to a concrete pilaster, wall, post, or column. The corner protector system can be applied to a variety of different types of corners such as right angle corners, 60° corners, or 30° corners. The corner protection system has an edge panel. The edge panel is configured to conform to a corner and configured to cover a corner edge. A right panel connects to the edge panel and extends to the right of the edge panel. The left panel connects to the edge panel and extends to the left of the left panel. The edge panel folds between a flat configuration and a right angle folded configuration. The right panel has a right panel overlap that overlaps the edge panel. The left panel has a left panel overlap that overlaps the edge panel. The edge panel has a plurality of edge panel fold relief slots. The right panel has right panel rail sliders, and the left panel has left panel rail sliders.

The right panel has a right panel anchor and wherein the left panel has a left panel anchor. The right panel anchor is configured to connect to a first corner depression on a concrete column. The left panel anchor is configured to connect to a second corner depression on a concrete column. The front bumper is mounted to a lower front frame extension of a shopping cart. The lower front frame extension of the shopping cart forms a bend corner. A pair of front bumpers can be placed on the front bends of the lower front frame extension of the shopping cart. A rear bumper can be mounted to the shopping cart. The rear bumper is mounted as a rear wheel frame cover of a shopping cart.

The lower extension further includes a lower retainer opening with an axle extension relief. The axle extension relief is wider than the lower retainer opening. The lower retainer opening passes through the rear bumper. The lower retainer opening is configured to attach to a shopping cart real wheel frame. The rear bumper has a front stabilizing abutment and a rear stabilizing abutment extending inwardly from an upper extension. The front stabilizing abutment and rear stabilizing abutment define an inside retaining channel that secures to the shopping cart rear wheel frame.

### BRIEF DESCRIPTION OF THE DRAWINGS

FIG. 1 is a top view of the present invention showing the concrete corner in cross-section.

FIG. 2 is a front perspective view of the present invention.

FIG. 3 is a front view of the present invention.

FIG. 4 is a side view of the present invention in unfolded configuration.

FIG. 5 is an installed view of the present invention.

FIG. 6 is a diagram showing the front bumper and rear bumper attachment on a shopping cart.

FIG. 7 is an outside view of the rear bumper.

FIG. 8 is an inside view of the rear bumper.

FIG. 9 is a top perspective view of the front bumper

The following call out list of elements can be a useful guide in referencing the element numbers of the drawings.
20 Corner Protector
21 Corner
22 Corner Surface
23 First Corner Depression
24 Second Corner Depression
25 Corner Matrix
26 Corner Edge
27 Right Corner Wall
28 Left Corner Wall
29 Concrete
30 Right Panel
31 Right Panel Right Edge
32 Right Panel Overlap
33 Right Panel Anchor
34 Right Panel Indent
35 Right Panel Rail Sliders
36 Right Rail Slider Upper Edge
37 Right Rail Slider Lower Edge
38 Right Outer Margin
39 Right Lower Margin
40 Left Panel
41 Left Panel Left Edge
42 Left Panel Overlap
43 Left Panel Anchor
44 Left Panel Indent
45 Left Panel Rail Sliders
46 Left Rail Slider Upper Edge
47 Left Rail Slider Lower Edge
48 Left Outer Margin
49 Left Lower Margin
50 Edge Panel
51 Edge Panel Joint
52 Edge Panel Fold Relief Slots
53 Groove
54 Ridge
55 Right Junction Gap
56 Left Junction Gap
57 Array Of Ridges And Grooves
91 Upper Bevel
92 Lower Bevel
60 Shopping Cart
61 Shopping Cart Basket
62 Shopping Cart Handle
63 Shopping Cart Rear Wheel
64 Shopping Cart Front Wheel
65 Shopping Cart Frame
66 Front Bumper
67 Shopping Cart Rear Wheel Frame
68 Rear Wheel Frame Cover
70 Rear Bumper
71 Axle Extension Relief
72 Lower Retainer Opening
73 Rear Stabilizing Abutment
74 Front Stabilizing Abutment
76 Upper Extension
77 Lower Extension
78 Outside Center Channel
79 Inside Retaining Channel
80 Bend Cover
81 First Bend Cover Frame Receiver Opening
82 Second Bend Cover Frame Receiver Opening
83 Connecting Web
84 Webbing Aperture

### DETAILED DESCRIPTION OF THE PREFERRED EMBODIMENT

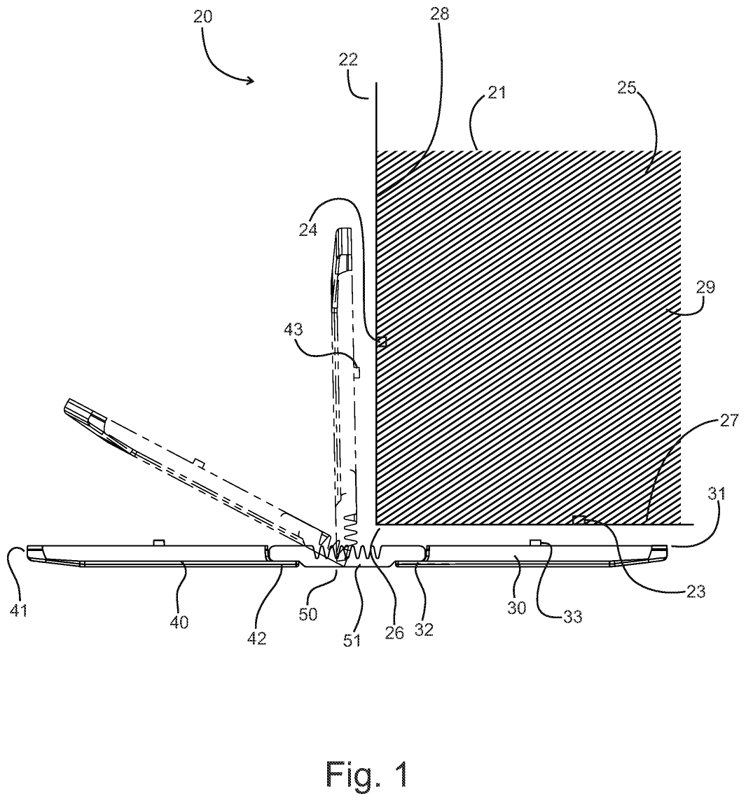

FIG. 1 shows a top view of the present invention in an exploded view about to be attached to a concrete corner. The corner 21 is made of concrete 29. The concrete 29 is in a matrix such as a corner matrix 25 which can be comprised of aggregate such as stone and a binder such as cement. The corner 21 has a corner surface 22 and a pair of depressions including a first corner depression 23 and a second corner depression 24. The first corner depression 23 and the second corner depression 24 receive mounting from a right panel anchor 33 and a left panel anchor 43. The corner surface 22 bends at a 90° angle which rounds the corner between the left corner wall 28 and the right corner wall 27. The left corner wall 28 and the right corner wall 27 meet at a corner edge 26. The first corner depression 23 and the second corner depression 24 can be formed as cylindrical hollows having magnetic mounting. The magnetic mounting means can be in addition to a bolted or screw connection. The magnetic mounting can allow easy alignment so that the left panel 40 and the right panel 30 can be mounted to the corner 21 more easily. For a more permanent installation, adhesive can adhere the right panel 32 the right corner wall 27, and the left corner wall 28 to the left panel 40.

The magnetic mounting can be neodymium magnets mounted on the corner depressions which receive magnetic latching to a ferrous stud mounted to the panel anchors. A mechanical connection such as a screw connection can also connect the panel anchors to the corner depressions. The corner depressions can be drilled and aligned to the existing columns. Hardware can be epoxy bonded to the drilled openings to form the corner depressions. Thus, existing concrete columns can be retrofitted to receive the corner protection system. The panels can be plastic injection molded. The plastic injection molded panels can have embedded metal for magnetic attachment.

The right panel 30 and the left panel 40 are preferably formed of elastomeric material that are polymer. The panel system preferably includes a right panel 30 connected to an edge panel 50 which in turn is connected to a left panel 40. The left panel 40 has a left panel left edge which opposes a right panel right edge 31 of the right panel 30. The edge panel 50 is mounted between the right panel 30 in the left panel 40. The edge panel 50 receives a right panel overlap 32 which extends from the right panel 30 over the edge panel 50. Also, the left panel 40 has a left panel overlap 42 that extends over a portion of the edge panel 50. The edge panel 50 has an edge panel joint 51. The edge panel 50 can be made of a softer material than the right panel 30 and the left panel 40 which can allow for a foldable edge panel joint 51.

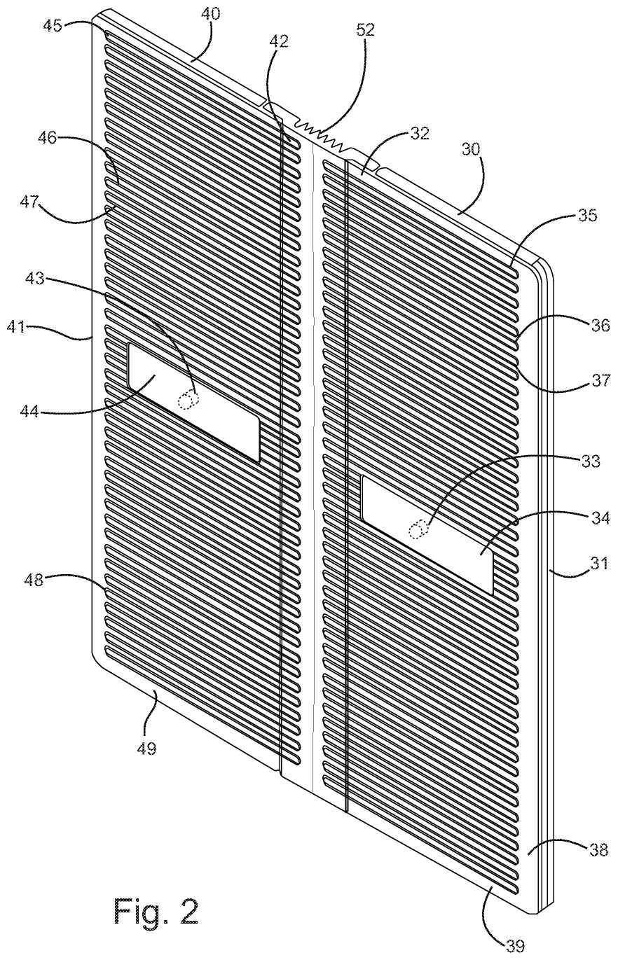

As seen in FIG. 2, the right panel 30 in the left panel 40 have a variety of different features optimized for shopping cart abrasion. The right panel 30 has right panel rail sliders 35 and the left panel 40 has left panel rail sliders 45. The rail sliders help the shopping cart bumpers glide along the edge of the panels. The rail sliders can be protrusions or depressions. The right panel rail sliders 35 have right rail slider upper edges 36 and right real slider lower edges 37. The left panel rail sliders 45 have left rail slider upper edges 46 and left rail slider lower edges 47. In addition, the right panel has a right panel indent 34 and the left panel has a left panel indent 44. The left panel indent 44 can aligned to the left panel anchor 43. The right panel indent 34 can aligned to the right panel anchor 33.

On an inside surface of the edge panel 50, edge panel fold relief slots 52 allow for the edge panel joint 51 to bend around a corner such as a 90° corner, 60° corner or 30° corner. The edge panel fold relief slots 52 are preferably formed as angled slots that are formed of elastomeric materials such that they can allow for impact resistance.

The rail sliders have margins on the panels. For example, the right panel 30 has a right outer margin 38 and a right lower margin 39 where the right rail sliders 35 do not extend to the right panel edge 31. Similarly, the left panel 40 has a left outer margin 48 and a left lower margin 49 where the left panel rail sliders 45 do not extend to the left panel edge 41.

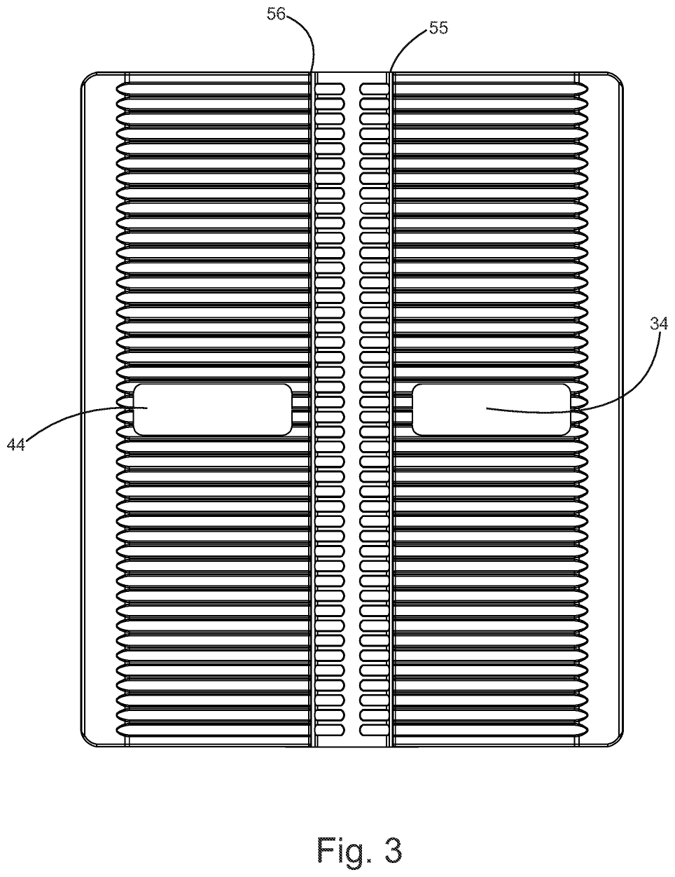

As seen in FIG. 3, the right panel 30 is a mirror image of the left panel. The right panel 30 has an upper bevel 91 and a lower bevel 92. The side view shows an array of ridges and grooves 57. Individual ridges 54 and grooves 53 are horizontal. The right junction gap 55 runs vertically along the edge of the right panel 30. The right real slider upper edge 36 and the right real slider lower edge 37 are also horizontal and facilitate a smooth wiping of a shopping cart bumper along the surface of the right panel or the left panel.

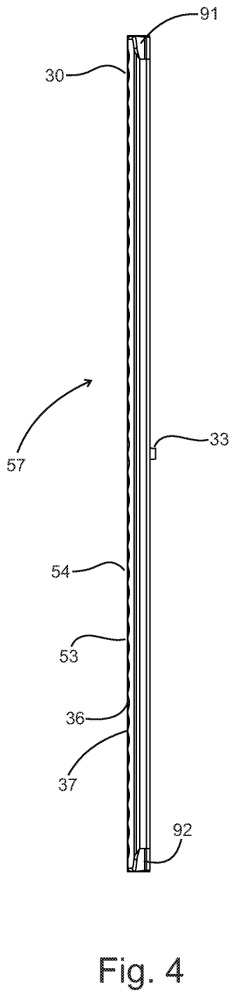

As seen in FIG. 4, the right junction gap 55 is parallel to the left junction gap 56. Both of the junction gaps overlay the middle panel which is the edge panel 50. The junction gap provides a impact isolation such that impact on a right panel does not transfer to the middle panel for example. Also, impact on the left panel does not transfer forced to the right panel. Segmenting the panels provides shock and vibration isolation which prevents panel shifting.

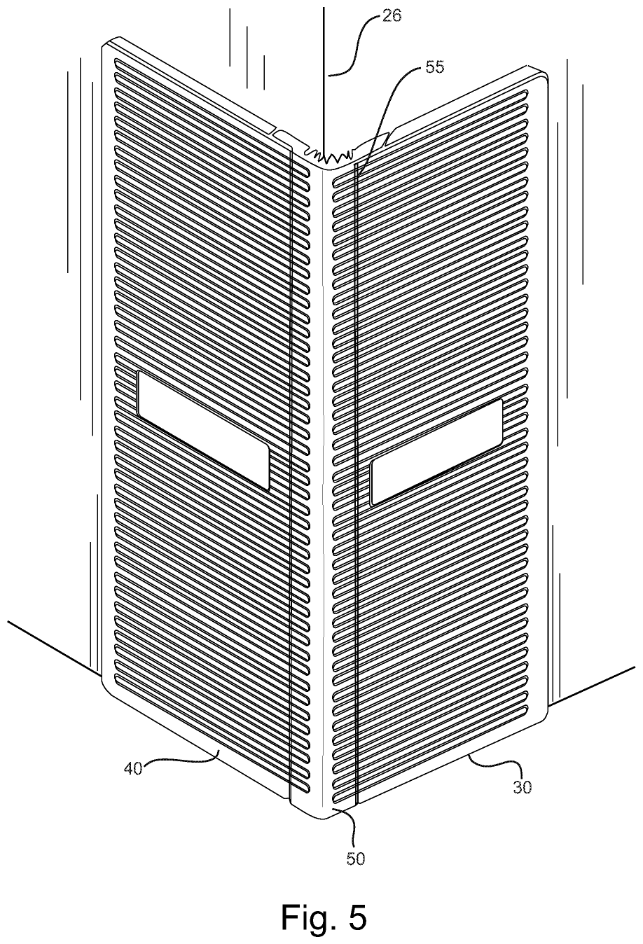

As seen in FIG. 5, the panel installs to the corner edge 26 and folds from a flat position to a folded position. The right panel 30 fits to the edge panel 50 which fits to the left panel 40. The edge panel 50 conforms around the corner edge 26. When a shopping cart hits the right panel or the left panel, the wiping impact slides along the panel surface to deflect force.

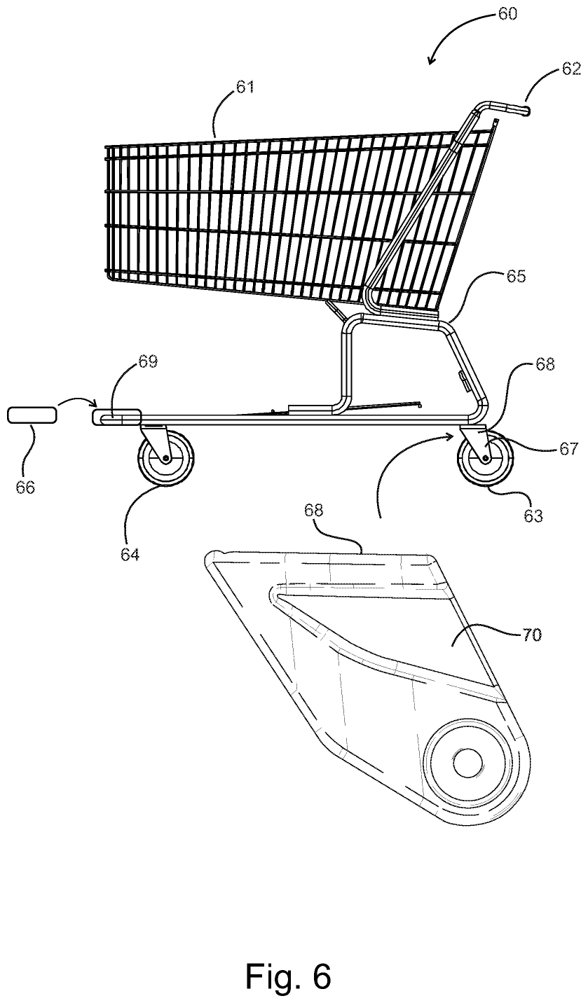

As seen in FIG. 6, the shopping cart has a shopping cart basket 61 and a shopping cart handle 62. The shopping cart frame 65 retains the basket and handle. The shopping cart frame extends downwardly to a lower front frame. The lower front frame has a lower front frame extension 69. The front bumper 66 attaches to the lower front frame extension 69. The shopping cart 60 has a shopping cart front wheel 64 and a shopping cart rear wheel 63. The shopping cart front wheel 64 is below the lower front frame extension 69. The front bumper 66 is mounted above the shopping cart front wheel 64. The shopping cart rear wheel 63 is mounted on a shopping cart rear wheel frame 67. A rear bumper 70 is mounted to the shopping cart rear wheel frame as a rear wheel frame cover 68.

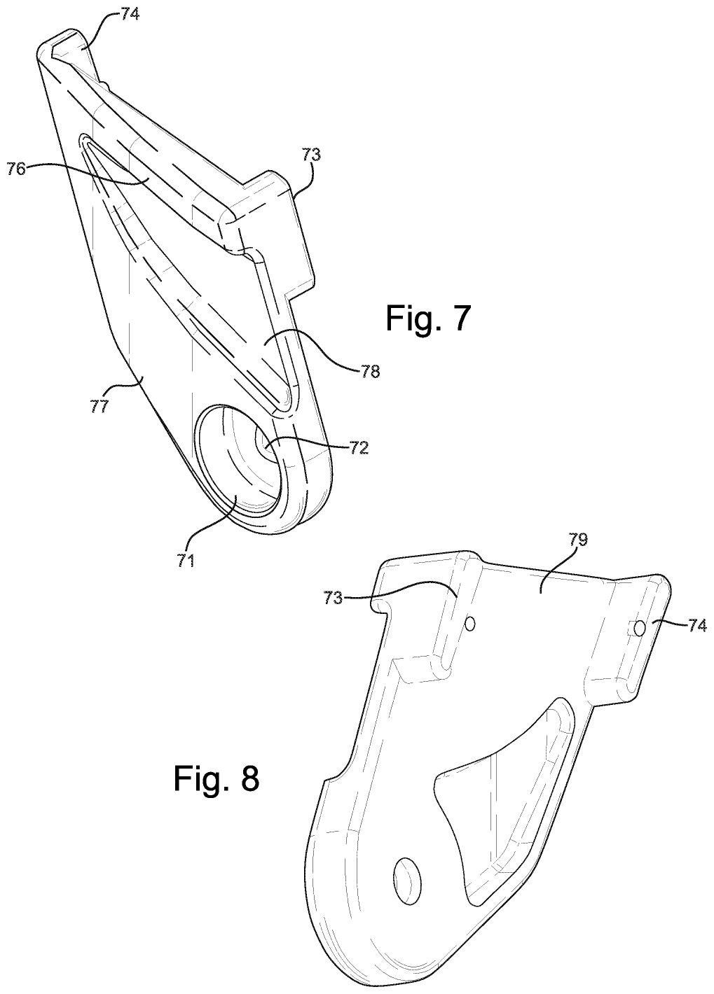

As seen in FIG. 7, the shopping cart rear wheel frame cover 68 has a front stabilizing abutment 74 and a rear stabilizing abutment 73 which extend around a front and rear edge of the shopping cart rear wheel frame 67. An upper extension 76 extends horizontally between the front stabilizing abutment 74 and the rear stabilizing abutment 73. The upper extension 76 extends outwardly over an outside center channel 78. A lower extension 77 covers the front lower edge of the shopping cart rear wheel frame 67. The lower extension 77 further includes a lower retainer opening 72 and an axle extension relief 71. An axle of the shopping cart rear wheel 63 is threaded and can receive a nut. The axle extension relief 71 provides a cylindrical opening which can receive a nut socket for driving a nut. A nut can be mounted to the lower retainer opening 72 on the lower extension 77. Thus, the rear bumper 70 can attach and retrofit to an existing shopping cart rear wheel frame 67.

As seen in FIG. 8, an inside view of the shopping cart rear wheel frame cover 68 shows that a flat outside surface of the shopping cart rear wheel frame 67 lodges within the inside retaining channel 79 between the front stabilizing abutment 74 and the rear stabilizing abutment 73. Typically, the front stabilizing abutment 74 and the rear stabilizing abutment 73 are angled forwardly according to a traditional shopping cart rear wheel frame design, however the angles can be modified should different shopping cart rear wheel frame designs become popular. The inside view of the shopping cart rear wheel frame cover 60 also shows a lower retainer opening 72 which passes from an inside surface of the inside retaining channel 79 to an outside surface of the lower extension 77.

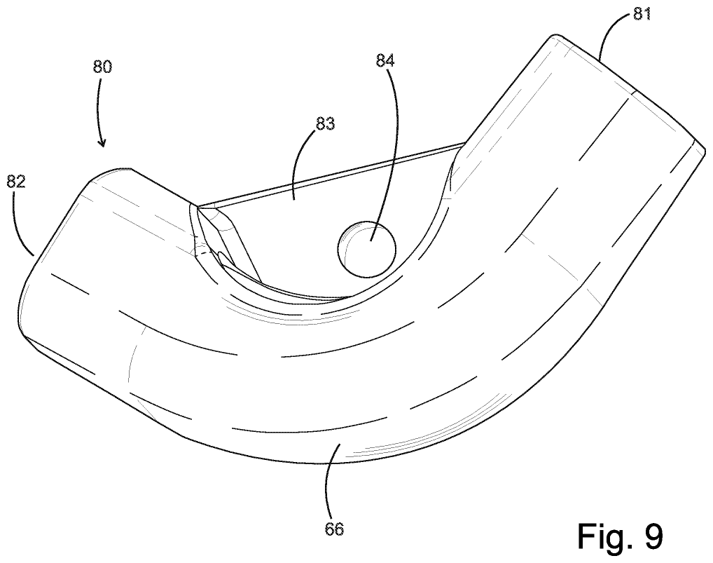

As seen in FIG. 9, the front bumper 66 connects to the front frame extension 69. The front bumper 66 bends around an edge of the lower front frame extension 69. The lower front frame extension 69 is formed as a metal tube with a bend. The front bumper 66 conforms to the bend of the metal tube of the lower front frame extension 69. The from bumper 66 further includes a first bend cover frame receiver opening 81 and a second bend cover frame receiver opening 82. The front bumper 66 can be formed as a bend cover 80. The bend cover 80 also has a connecting web 83. The connecting web has a webbing aperture 84. A pair of front bumpers and a pair of rear bumpers can attach to a shopping cart having a rectangular configuration. On certain shopping carts, the webbing aperture 84 can be used to connect to the shopping cart frame such as by a nut and washer.

During use, the shopping cart front bumper and shopping cart rear bumper may collide with the rail sliders on the panels. The slick surface of the front bumper and rear bumper are configured to glide along the rail sliders to deflect impact and damage to the concrete corners. As the shopping cart bumpers and the panels degrade over time after thousands of collisions, the bumpers and panels can be replaced modularly as needed.

1. A corner protection system comprising:
a. an edge panel, wherein the edge panel is configured to conform to a corner and configured to cover a corner edge;
b. a right panel, wherein the right panel connects to the edge panel and extends to the right of the edge panel; and
c. a left panel, wherein the left panel connects to the edge panel and extends to the left of the left panel.

2. The corner protection system of claim 1, wherein the edge panel folds between a flat configuration and a right angle folded configuration.

3. The corner protection system of claim 1, wherein the edge panel further includes a plurality of edge panel fold relief slots.

4. The corner protection system of claim 1, wherein the right panel further includes right panel rail sliders, wherein the left panel further includes left panel rail sliders.

5. The corner protection system of claim 1, wherein the right panel has a right panel anchor and wherein the left panel has a left panel anchor, wherein the right panel anchor is configured to connect to a first corner depression on a concrete column, wherein the left panel anchor is configured to connect to a second corner depression on a concrete column.

6. The corner protection system of claim 1, further including a front bumper, wherein the front bumper is mounted to a lower front frame extension of a shopping cart.

7. The corner protection system of claim 1, further including a rear bumper mounted to a shopping cart, and wherein the rear bumper is mounted as a rear wheel frame cover of a shopping cart.

8. The corner protection system of claim 1, wherein the lower extension further includes a lower retainer opening with an axle extension relief, wherein the axle extension relief is wider than the lower retainer opening, wherein the lower retainer opening passes through the rear bumper, wherein the lower retainer opening is configured to attach to a shopping cart real wheel frame.

9. The corner protection system of claim 8, wherein the rear bumper has a front stabilizing abutment and a rear stabilizing abutment extending inwardly from an upper extension, wherein the front stabilizing abutment and rear stabilizing abutment define an inside retaining channel that secures to the shopping cart rear wheel frame.

10. The corner protection system of claim 1, wherein the right panel further includes a right panel overlap that overlaps the edge panel, wherein the left panel further includes a left panel overlap that overlaps the edge panel.

11. The corner protection system of claim 10, wherein the edge panel folds between a flat configuration and a right angle folded configuration.

12. The corner protection system of claim 10, wherein the edge panel further includes a plurality of edge panel fold relief slots.

13. The corner protection system of claim 10, wherein the right panel further includes right panel rail sliders, wherein the left panel further includes left panel rail sliders.

14. The corner protection system of claim 10, wherein the right panel has a right panel anchor and wherein the left panel has a left panel anchor, wherein the right panel anchor is configured to connect to a first corner depression on a concrete column, wherein the left panel anchor is configured to connect to a second corner depression on a concrete column.

15. The corner protection system of claim 10, further including a front bumper, wherein the front bumper is mounted to a lower front frame extension of a shopping cart.

16. The corner protection system of claim 10, further including a rear bumper mounted to a shopping cart, and wherein the rear bumper is mounted as a rear wheel frame cover of a shopping cart.

17. The corner protection system of claim 10, wherein the lower extension further includes a lower retainer opening with an axle extension relief, wherein the axle extension relief is wider than the lower retainer opening, wherein the lower retainer opening passes through the rear bumper, wherein the lower retainer opening is configured to attach to a shopping cart real wheel frame.

18. The corner protection system of claim 17, wherein the rear bumper has a front stabilizing abutment and a rear stabilizing abutment extending inwardly from an upper extension, wherein the front stabilizing abutment and rear stabilizing abutment define an inside retaining channel that secures to the shopping cart rear wheel frame.

19. The corner protection system of claim 10, wherein the edge panel folds between a flat configuration and a right angle folded configuration, wherein the edge panel further includes a plurality of edge panel fold relief slots, wherein the right panel further includes right panel rail sliders, wherein the left panel further includes left panel rail sliders, wherein the right panel has a right panel anchor and wherein the left panel has a left panel anchor, wherein the right panel anchor is configured to connect to a first corner depression on a concrete column, wherein the left panel anchor is configured to connect to a second corner depression on a concrete column.

20. The corner protection system of claim 10, further including a front bumper, wherein the front bumper is mounted to a lower front frame extension of a shopping cart, further including a rear bumper mounted to a shopping cart, and wherein the rear bumper is mounted as a rear wheel frame cover of a shopping cart.
